(19) United States
(12) Patent Application Publication
(10) Pub. No.: US 2015/0012616 A1
(43) Pub. Date: Jan. 8, 2015

(54) Saving Third Party Content to a Content Management System

(71) Applicant: Dropbox, Inc., San Francisco, CA (US)

(72) Inventors: Ryan Pearl, San Francisco, CA (US); Ayman Nadeem, Mississauga (CA); Sean Lynch, San Francisco, CA (US)

(73) Assignee: Dropbox, Inc., San Francisco, CA (US)

(21) Appl. No.: 14/064,105

(22) Filed: Oct. 25, 2013

Related U.S. Application Data
(60) Provisional application No. 61/843,783, filed on Jul. 8, 2013.

(51) Int. Cl. H04L 29/08

(52) U.S. Cl. CPC H04L 67/1095
USPC 709/219

(57) ABSTRACT

A content management system interacts with a content provider to store content items of the content provider within content storage of the content management system, where it is available to the users. Before obtaining and/or storing a content item of a content provider, the content management system determines whether it already has stored that content item, either for the same user or for other users of the content management system. In one embodiment, the content management system may include content subscription functionality that manages subscriptions of users to content of a content provider. In one embodiment, the subscription functionality handles the establishment of requested subscriptions, which includes identifying groups of users who have the same subscriptions, and also handles obtaining new content items provided by the content providers as part of those subscriptions.

### CROSS REFERENCE TO RELATED APPLICATIONS

The application claims the benefit of Provisional Application No. 61/843,783, filed on Jul. 8, 2013, which is hereby incorporated herein by reference.

### TECHNICAL FIELD

The disclosed embodiments relate generally to sharing media files over a network. In particular, the disclosed embodiments are directed to efficiently obtaining and sharing content provided by a third-party content provider.

### BACKGROUND

A content management system permits users to store content in association with their accounts on the content management system. Some of the content that users typically store is user-generated, or otherwise specific to the user that stored the content. However, certain items of content tend to be globally popular across users, such as podcasts, videos, e-books, and other types of content obtained from third party content providers. Thus, it is common for the same content item (e.g., a popular video) to be stored by many different users of a content management system, such as thousands or even millions of users. This duplication of content items represents an inefficient use of computing resources, such as network resources (e.g. server data transfer load) and of storage resources (e.g., multiple copies of content items stored within the content management systems).

### SUMMARY

A content management system interacts with a content provider to store user-requested content items of the content provider within content storage of the content management system, where it is available to the users. Before storing a content item of a content provider, the content management system determines whether it already has stored that content item, either for the same user or for other users of the content management system. If the content item has already been stored for one user, then it need not be stored again for a different user; rather, it is possible to store only a single copy of the content item on the content management system, making the single copy made available to all the users who have requested it. The single copy may further be synchronized across the different client devices associated with the users who requested the content item.

In one embodiment, the content management system includes content subscription functionality that manages subscriptions of users to content of a content provider. In one embodiment, the subscription functionality handles the establishment of requested subscriptions, which includes identifying groups of users who have the same subscriptions, and also handles obtaining new content items provided by the content providers as part of those subscriptions. Obtaining new content items involves requesting new content items from the content provider at different times, such as periodic intervals defined by a specified update frequency of content items associated with the subscription. By identifying users who share a given subscription, the content management system need only obtain a new content item associated with a subscription once for all the subscribers, thereby saving significant network and storage resources in many cases.

The content management system may determine whether it has already stored a given content item in different ways in different embodiments. For example, in one embodiment a request to store a content item specifies a uniform resource locator (URL) corresponding to the content item, and the content management system determines whether that URL is already present in an entry of content storage in which the various content items are stored. In another embodiment, the content management system computes a digital fingerprint of the content item and determines whether content items already stored in the content storage share the same digital fingerprint.

The features and advantages described in this summary and the following detailed description are not all-inclusive. Many additional features and advantages will be apparent to one of ordinary skill in the art in view of the drawings, specification, and claims hereof.

### BRIEF DESCRIPTION OF THE DRAWINGS

FIG. 1 shows a diagram of a system environment of a content management system and a content provider, according to one embodiment.

FIG. 2 shows the content of an example web page of a content provider web site providing podcast audio files.

FIG. 3 shows an example user interface for specifying details about how a content item is to be saved to a content management system, according to one embodiment.

FIG. 4 shows one embodiment of components of a client device.

FIG. 5 shows components of a content management system, according to one embodiment.

FIG. 6 shows actions that take place when a user saves a single content item, according to one embodiment.

FIG. 7 shows actions that take place when a user obtains content items via a subscription, according to one embodiment.

FIG. 8 shows actions that take place when a user saves a single content item, according to one embodiment.

FIG. 9 shows actions that take place when a user obtains content items via a subscription, according to one embodiment.

The figures depict various embodiments of the present invention for purposes of illustration only. One skilled in the art will readily recognize from the following description that other alternative embodiments of the structures and methods illustrated herein may be employed without departing from the principles of the invention described herein.

### DETAILED DESCRIPTION

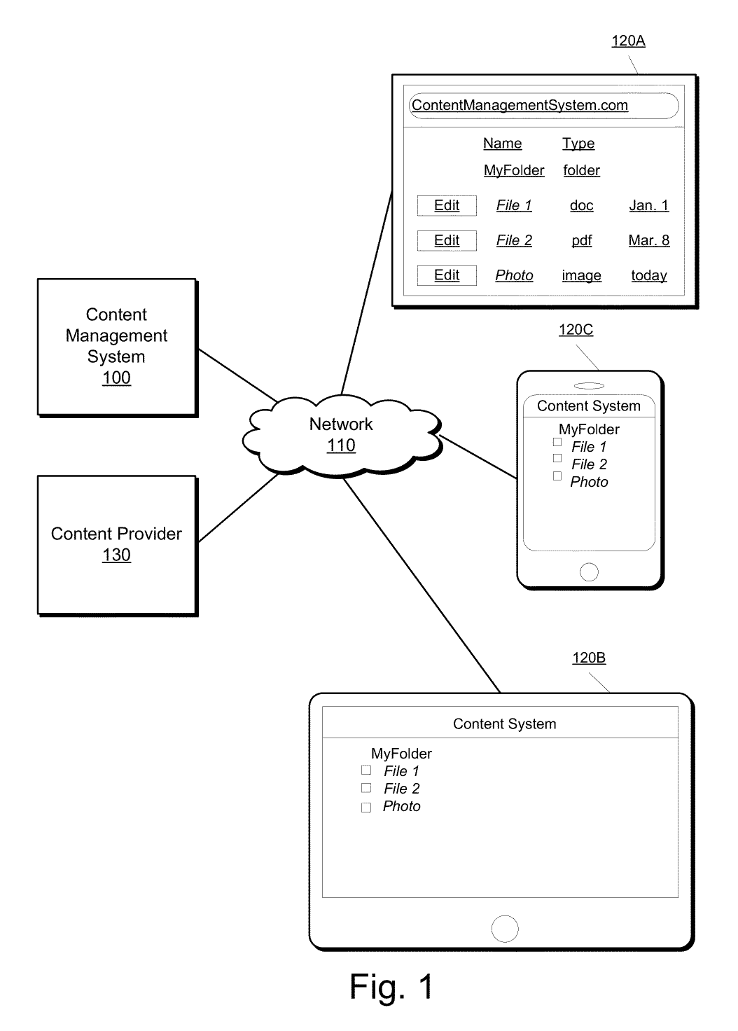

FIG. 1 shows a system environment including content management system 100, content provider 130, and client devices 120A, 120B, 120C (collectively or individually “120”). Content management system 100 provides content sharing and synchronization services for users of client devices 120. These services allow users to share content with other users of client devices 120. In addition to content sharing, content management system 100 updates shared content responsive to changes and enables users to synchronize changes across multiple client devices 120. A user may synchronize content across multiple client devices 120 owned by the user and associated with the user's account, and the user may share content that is synchronized with devices associated with other users' accounts. The content stored by content management system 100 can include any type of data, such as digital data, documents, media (e.g., images, photos, videos, audio, streaming content), data files and databases, source and object code, recordings, and any other type of data or file, hereinafter collectively referred to as “content items.” The content stored by content management system 100 may be organized in one configuration in folders, tables, collections, or in other database structures (e.g., object oriented, key/value etc.). The content stored by the content management system 100 may include content provided by one or more content providers 130.

In the environment illustrated in FIG. 1, each of client devices 120 accesses content through content management system 100. Thus, each client device 120 may jointly access various types of content, such as a folder MyFolder containing files such as file 1, file 2, and photo. Various types of devices can function as a client device, such as desktop computer 120A, tablet computer 120B, and mobile device 120C. Any device capable of accessing content management system 100 and interacting with the content items stored on content management system 100 may be used as a client device 120.

Users may create accounts at content management system 100 and store content thereon by transmitting such content from client device 120 to content management system 100. Users may also store content to content management system 100 by (for example) requesting transfer of content items from content providers 130 to content management system 100. The content provided by users is associated with user accounts that may have various privileges. The privileges may include viewing the content item, modifying the content item, modifying user privileges related to the content item, and deleting the content item.

Content provider 130 is a computer system providing digital content. Examples of the provided digital content include electronic books, podcasts, video, news stories, or any other form of electronic content that can be consumed (e.g., viewed, listened to) using a computing device. The content provider 130 can make the content available to the various client devices 120 in different manners. For example, in one embodiment the content provider 130 makes each distinct item of content—such as a particular audio podcast or electronic book—available via a corresponding uniform resource locator (URL). In one embodiment, a series of related items—such as a set of podcasts on a particular topic—is made available over time via the same URL (e.g., www.pjap-podcasts.com/characters/), or via different URLs (e.g., URLs related by their URL prefixes, such as http://www.pjap-podcasts.com/novels/062913_Udolpho.mp3 and http://www.pjap-podcasts.com/subscriptions/novels/063013_Udolpho.mp3). There may be any number of different content providers 130, each providing any type (or multiple types) of content.

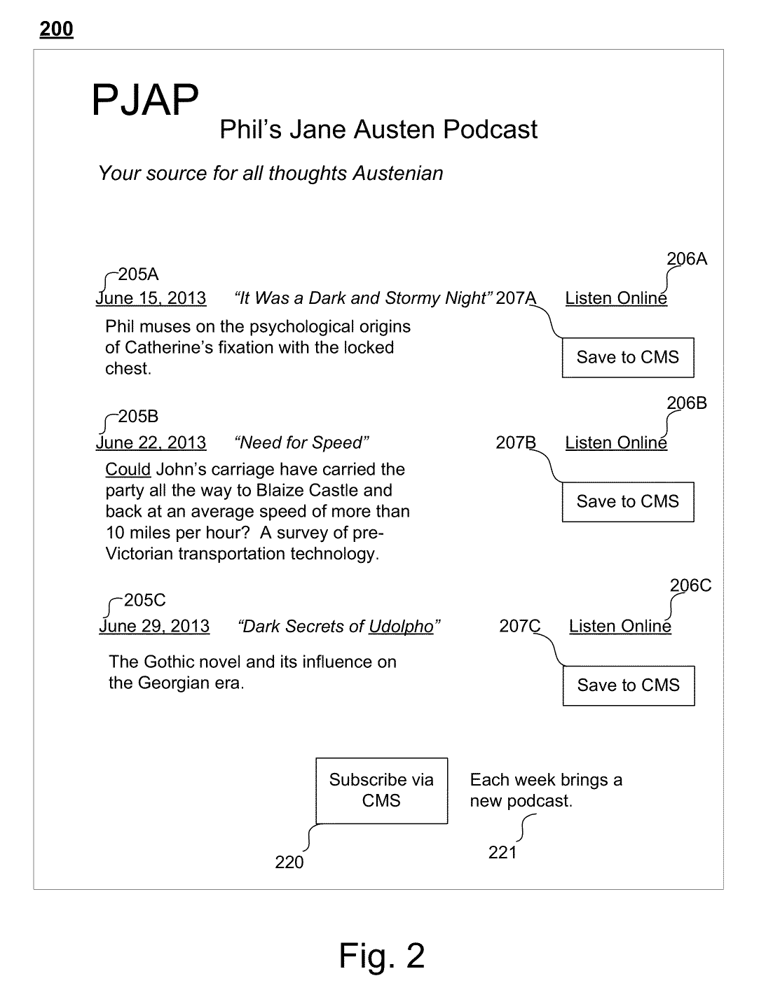

Content provider 130 can make items of content available in different manners, such as via links or other user interface elements included in web pages, or via specialized applications designed specifically to facilitate access to content of the content provider 130. For example, FIG. 2 shows the content of example web page 200 of a content provider web site providing podcast audio files. Web page 200 provides access to three audio files illustrated as 205A-C. Links 206 specify the corresponding audio files, causing a client device 120 to download and play the audio. Alternatively, buttons 207 provide a way for a user having an account on a particular content management system 100 (named “CMS” in the illustrated example) to save a copy of the corresponding audio file to the user's account. The user can then later access the saved audio file when using the content management system 100. The example web page 200 additionally provides a subscription button 220 that causes new audio files produced by the web site to likewise be saved to the user's account on the content management system 100. For instance, the example of FIG. 2 indicates in message 221 that new podcasts are provided on a weekly basis, and thus a subscription would lead a new podcast audio file to be saved to the user's account on the content management system 100 each week, e.g., by content management system 100 automatically downloading it from the content provider 130 to the content management system 100.

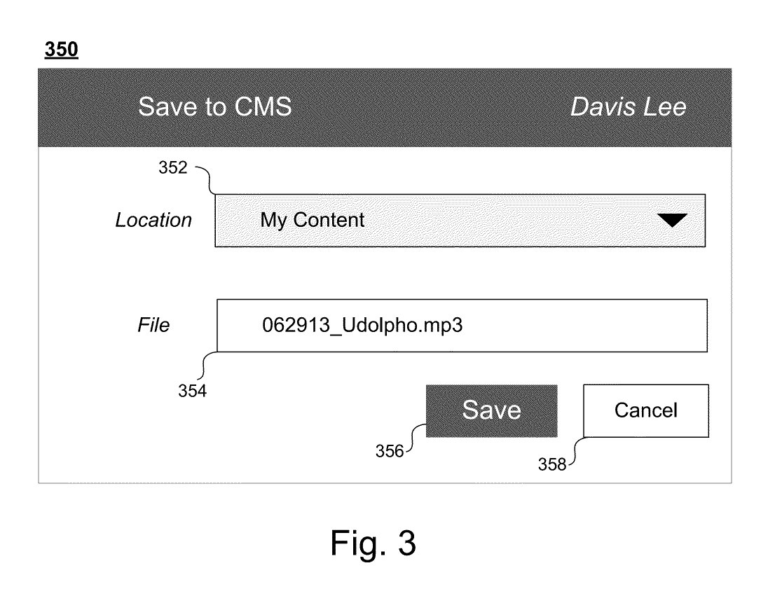

In one embodiment, selecting button 207 causes the corresponding file to be saved to a predetermined location in the content management system 100 (e.g., to a default folder for downloaded content) under a default name, without any further user interaction. In another embodiment shown in FIG. 3, selecting button 207 leads to user interface 350 used to specify additional details about how the content item should be saved. For example, folder selection user interface element 352 indicates that content item 205C will be saved in a folder named “My Content,” e.g., a default content folder for the user, and filename text area 354 indicates that it will be saved under the name “062913_Udolpho.mp3” (a name that the user can change if desired). In one embodiment, the user interface 350 is implemented as a pop-up dialog, as illustrated in FIG. 3, though in other embodiments user interface 350 could be implemented in other manners, such as an iframe embedded within web page 200.

In one embodiment, if the user is not already signed in to the content management system 100, a login process of the content management system is begun in response to the user selecting button 220 or 207. Specifically, a login form is provided in which the user enters login information such as username and password, and the provided information is sent to content management system for verification. Upon successful login (e.g., content management system 100 verifies that the username and password pair are correct), the user interface 350 is then displayed.

In order to provide functionality for saving content items to content management system 100, such as buttons 207 or subscribe button 220 of FIG. 2, content provider 130 may use an API of content management system 100. For example, content provider 130 might implement button 207C by including scripting code such as JavaScript within the web page 200, e.g., via the HTML code <script type=“text/javascript” src=“http://api.cms.com/s/savebutton.js”></script>.

In response, a client device 120 would request the scripting code defining button 207C (namely, “savebutton.js”) from a server of content management system 100 with a domain name “server api.cms.com”, and the server would provide the code to the client device 120 for incorporation into the web page 200. Assume for purposes of example that the code “savebutton.js” defines a class as follows:

CMS.saveURL(URL, contentItem, {

success: function(data) { },
progress: function(progress) { },
error: function(err) { }

});

where URL is a string or a list of strings listing URLs of content items to be saved, contentItem is a default name under which to save the content item(s), and success, progress, and error are callback functions that are called when a user completes the save UI action, when the content item has been saved to content management system 100, and if/when content management system 100 has failed to respond, respectively. (The function could also automatically pass an identifier of the user currently logged in to the content management system 100, without any need to pass the function an express argument.) In this example, the web page 200 could associate the selection of button 207C (e.g., an onclick action) with a call to the CMS.saveURL function, passing it the URL of the content item and the default name of the content item (and any desired callback functions). For example, the code for button 207C might be CMS.saveURL (“http://www.pjap-podcasts.com/062913_Udolpho.mp3”, “062913_Udolpho.mp3”), causing the content item made available by content provider 130 at http://www.pjap-podcasts.com/062913_Udolpho.mp3 to be saved by default under the name 062913_Udolpho.mp3.

Alternatively, web page 200 could include code for button 207C that embodies both the appearance and the behavior of the button, such that the button when clicked will automatically use the API of content management system 100 (e.g., CMS.saveURL). For example, button 207C could be implemented with the code

<input type=“CMS-saver” style=“visibility: hidden;”
data-url=“http://www.pjap-podcasts.com/062913_Udolpho.mp3”
data-filename= “062913_Udolpho.mp3” />.

This accomplishes the same result as the prior example, assuming that the CMS-saver type was defined in the code savebutton.js in the same manner as the CMS.saveURL function.

It is appreciated that although in the specific example of FIG. 2 the user interface for accessing content items 205 is a web page, other user interfaces could also be employed. For example, the user interface could be that of a custom application designed to provide access to the content of a particular content provider 130.

Referring again to FIG. 1, client devices 120 communicate with content management system 100 and content provider 130 through network 110. The network may be any suitable communications network for data transmission. In one embodiment, network 110 is the Internet and uses standard communications technologies and/or protocols. Thus, network 110 can include links using technologies such as Ethernet, 802.11, worldwide interoperability for microwave access (WiMAX), 3G, digital subscriber line (DSL), asynchronous transfer mode (ATM), InfiniBand, PCI Express Advanced Switching, etc. Similarly, the networking protocols used on network 110 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc. The data exchanged over network 110 can be represented using technologies and/or formats including the hypertext markup language (HTML), the extensible markup language (XML), etc. In addition, all or some of links can be encrypted using conventional encryption technologies such as the secure sockets layer (SSL), transport layer security (TLS), virtual private networks (VPNs), Internet Protocol security (IPsec), etc. In another embodiment, the entities use custom and/or dedicated data communications technologies instead of, or in addition to, the ones described above.

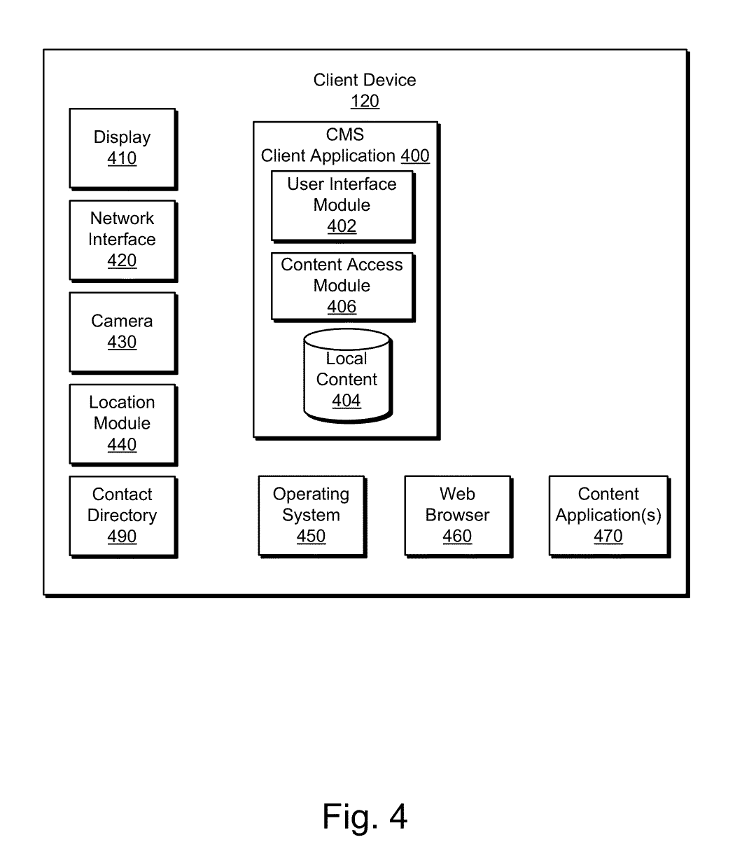

FIG. 4 shows one embodiment of components of client device 120. Client device 120 generally includes devices and modules for communicating with content management system 100 and a user of client device 120. Client device 120 includes display 410 for providing information to the user, and in certain client devices 120 includes a touchscreen. Client device 120 also includes network interface 420 for communicating with content management system 100 via network 110. Other conventional components of a client device 120 that are not material are not shown, for example, one or more computer processors, local fixed memory (RAM and ROM), as well as optionally removable memory (e.g., SD-card), power sources, and audio-video outputs.

Client devices 120 maintain various types of components and modules for operating the client device and accessing content management system 100. The software modules include operating system 450 and one or more content applications 470. Content applications 470 vary based on the client device, and may include various applications for creating, viewing, and/or modifying content stored on content management system 100, such as word processors, spreadsheets, database management systems, code editors, image and video editors, and the like. Content applications 470 may include applications for consuming the content provided by the content provider 130, such as an e-book reader application for displaying e-books provided by the content provider 130, an audio player for playing podcast audio files, and the like. Content applications 470 may also include applications specifically designed to access content of content provider 130, e.g., as an alternative to accessing the content via web browser 460. Operating system 450 on each device provides a local file management system and executes the various software modules such as content management system client application 400 and content application 470. A contact directory 490 stores information on the user's contacts, such as name, telephone numbers, company, email addresses, physical address, website URLs, and the like.

Client devices 120 access content management system 100 in a variety of ways. Client device 120 may access content management system 100 through a native application or software module, such as content management system client application 400. A schematic example display from a client application is shown in FIG. 1 on client devices 120B and 120C. Client device 120 may also access content management system 100 through web browser 460 as shown on client device 120A. As an alternative, the client application 400 may integrate access to content management system 100 with the local file management system provided by operating system 450. When access to content management system 100 is integrated in the local file management system, a file organization scheme maintained at content management system is represented as a local file structure by operating system 450 in conjunction with client application 400.

Client application 400 manages access to content management system 100. Client application 400 includes user interface module 402 that generates an interface to the content accessed by client application 400, as variously illustrated herein, and is one means for performing this function. The generated interface is provided to the user by display 410. Client application 400 may store content accessed from a content storage at content management system 100 in local content 404. While represented here as within client application 400, local content 404 may be stored with other data for client device 120 in non-volatile storage. When local content 404 is stored this way, the content is available to the user and other applications or modules, such as content application 470, when client application 400 is not in communication with content management system 100. Content access module 406 manages updates to local content 404 and communicates with content management system 100 to synchronize content modified by client device 120 with content maintained on content management system 100, and is one means for performing this function. Client application 400 may take various forms, such as a stand-alone application, an application plug-in, or a browser extension.

In certain embodiments, client device 120 includes additional components such as camera 230 and location module 440. Location module 440 determines the location of client device 120, using for example a global positioning satellite signal, cellular tower triangulation, or other methods. Location module 440 may be used by client application 400 to obtain location data and add the location data to metadata about a content item.

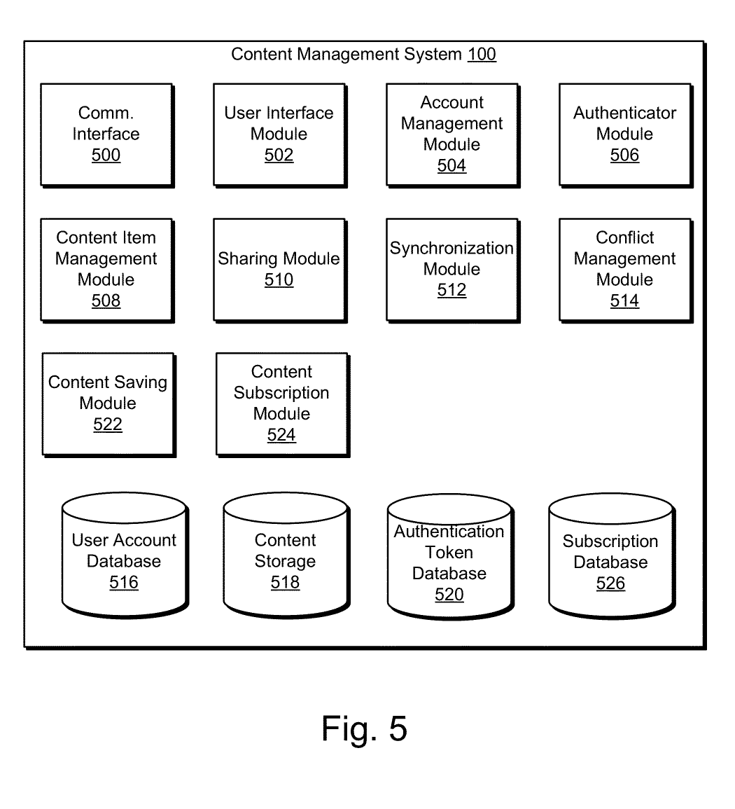

FIG. 5 shows components of content management system 100 according to one embodiment. To facilitate the various content management services, a user can create an account with content management system 100. The account information can be maintained in user account database 516, and is one means for performing this function. User account database 516 can store profile information for registered users. In some cases, the only personal information in the user profile can be a username and/or email address. However, content management system 100 can also be configured to accept additional user information, such as password recovery information, demographics information, payment information, and other details. Each user is associated with an identifier, such as a userID or a user name.

User account database 516 can also include account management information, such as account type, e.g. free or paid; usage information for each user, e.g., file edit history; maximum storage space authorized; storage space used; content storage locations; security settings; personal configuration settings; content sharing data; etc. Account management module 504 can be configured to update and/or obtain user account details in user account database 516. Account management module 504 can be configured to interact with any number of other modules in content management system 100.

An account can be used to store content, such as documents, text files, audio files, video files, etc., from one or more client devices associated with the account. The content can also include folders of various types with different behaviors, or other content item grouping methods. For example, an account can include a public folder that is accessible to any user. The public folder can be assigned a web-accessible address. A link to the web-accessible address can be used to access the contents of the public folder. In another example, an account can include a photos folder that is intended for photos and that provides specific attributes and actions tailored for photos; an audio folder that provides the ability to play back audio files and perform other audio related actions; or other special purpose folders. In another example, an account can include a downloads folder that is the default folder in which content items from content servers 130 are stored. An account can also include shared folders or group folders that are linked with and available to multiple user accounts. The permissions for multiple users may be different for a shared folder.

The content can be stored in content storage 518, which is one means for performing this function. Content storage 518 can be a storage device, multiple storage devices, or a server. Alternatively, content storage 518 can be a cloud storage provider or network storage accessible via one or more communications networks. In one configuration, content management system 100 stores the content items in the same organizational structure as they appear on the client device. However, content management system 100 can store the content items in its own order, arrangement, or hierarchy.

Content storage 518 can also store metadata describing content items, content item types, and the relationship of content items to various accounts, folders, or groups. In one embodiment, the metadata for a content item can optionally include an identifier of a content provider 130 or other source from which the content item was obtained, such as a URL (e.g., http://www.pjap-podcasts.com/062913_Udolpho.mp3). The metadata for a content item can be stored as part of the content item or can be stored separately. In one configuration, each content item stored in content storage 518 can be assigned a system-wide unique identifier.

Content storage 518 can decrease the amount of storage space required by identifying duplicate files or duplicate segments of files. In one embodiment, for example, a content item may be shared among different users by including identifiers of the users within ownership metadata of the content item (e.g., an ownership list), while storing only a single copy of the content item and using pointers or other mechanisms to link duplicates with the single copy. Similarly, content storage 518 stores files using a file version control mechanism that tracks changes to files, different versions of files (such as a diverging version tree), and a change history. The change history includes a set of changes that, when applied to the original file version, produces the changed file version.

Content management system 100 automatically synchronizes content from one or more client devices, using synchronization module 512, which is one means for performing this function. The synchronization is platform-agnostic. That is, the content is synchronized across multiple client devices 120 of varying type, capabilities, operating systems, etc. For example, client application 400 synchronizes, via synchronization module 512 at content management system 100, content in client device 120's file system with the content in an associated user account on system 100. Client application 400 synchronizes any changes to specified content (e.g., content located in a designated folder or its sub-folders) with the synchronization module 512. Such changes include new, deleted, modified, copied, or moved files or folders. Synchronization module 512 also provides any changes to content associated with client device 120 to client application 400. This synchronizes the local content at client device 120 with the content items at content management system 100.

Conflict management module 514 determines whether there are any discrepancies between versions of a content item located at different client devices 120. For example, when a content item is modified at one client device and a second client device, differing versions of the content item may exist at each client device. Synchronization module 512 determines such versioning conflicts, for example by identifying the modification time of the content item modifications. Conflict management module 514 resolves the conflict between versions by any suitable means, such as by merging the versions, or by notifying the client device of the later-submitted version.

A user can also view or manipulate content via a web interface generated by user interface module 502. For example, the user can navigate in web browser 460 to a web address provided by content management system 100. Changes or updates to content in content storage 518 made through the web interface, such as uploading a new version of a file, are synchronized back to other client devices 120 associated with the user's account. Multiple client devices 120 may be associated with a single account and files in the account are synchronized between each of the multiple client devices 120.

Content management system 100 includes communications interface 500 for interfacing with various client devices 120, and with other content and/or service providers via an Application Programming Interface (API), which is one means for performing this function. Certain software applications access content storage 518 via an API on behalf of a user. For example, a software package, such as an app on a smartphone or tablet computing device, can programmatically make calls directly to content management system 100, when a user provides credentials, to read, write, create, delete, share, or otherwise manipulate content. Similarly, the API can allow users to access all or part of content storage 518 through a web site.

Content management system 100 can also include authenticator module 506, which verifies user credentials, security tokens, API calls, specific client devices, etc., to determine whether access to requested content items is authorized, and is one means for performing this function. Authenticator module 506 can generate one-time use authentication tokens for a user account. Authenticator module 506 assigns an expiration period or date to each authentication token. In addition to sending the authentication tokens to requesting client devices, authenticator module 506 can store generated authentication tokens in authentication token database 520. Upon receiving a request to validate an authentication token, authenticator module 506 checks authentication token database 520 for a matching authentication token assigned to the user. Once the authenticator module 506 identifies a matching authentication token, authenticator module 506 determines if the matching authentication token is still valid. For example, authenticator module 506 verifies that the authentication token has not expired or was not marked as used or invalid. After validating an authentication token, authenticator module 506 may invalidate the matching authentication token, such as a single-use token. For example, authenticator module 506 can mark the matching authentication token as used or invalid, or delete the matching authentication token from authentication token database 520.

Content management system 100 includes a sharing module 510 for sharing content publicly or privately, which is one means for performing this function. Sharing content publicly can include making the content item accessible from any computing device in network communication with content management system 100. Sharing content privately can include linking a content item in content storage 518 with two or more user accounts so that each user account has access to the content item. The content can also be shared across varying types of user accounts.

In some embodiments, content management system 100 includes a content management module 508 for maintaining a content directory that identifies the location of each content item in content storage 518, and allows client applications to request access to content items in the storage 518, and which is one means for performing this function. A content entry in the content directory can also include a content pointer that identifies the location of the content item in content storage 518. For example, the content entry can include a content pointer designating the storage address of the content item in memory. In some embodiments, the content entry includes multiple content pointers that point to multiple locations, each of which contains a portion of the content item.

In addition to a content path and content pointer, a content entry in some configurations also includes a user account identifier that identifies the user account that has access to the content item. In some embodiments, multiple user account identifiers can be associated with a single content entry indicating that the content item has shared access by the multiple user accounts.

To share a content item privately, sharing module 510 adds a user account identifier to the content entry associated with the content item, thus granting the added user account access to the content item. Sharing module 510 can also be configured to remove user account identifiers from a content entry to restrict a user account's access to the content item.

To share content publicly, sharing module 510 generates a custom network address, such as a URL, which allows any web browser to access the content in content management system 100 without any authentication. The sharing module 510 includes content identification data in the generated URL, which can later be used by content management system 100 to properly identify and return the requested content item. For example, sharing module 510 can be configured to include the user account identifier and the content path in the generated URL. The content identification data included in the URL can be transmitted to content management system 100 by a client device to access the content item. In addition to generating the URL, sharing module 510 can also be configured to record that a URL to the content item has been created. In some embodiments, the content entry associated with a content item can include a URL flag indicating whether a URL to the content item has been created.

Content management system 100 and content provider 130 may be implemented using a single computer, or a network of computers, including cloud-based computer implementations. For the purposes of this disclosure, a computer is device having one or more processors, memory, storage devices, and networking resources. The computers are preferably server class computers including one or more high-performance CPUs and 1G or more of main memory, as well as 500 Gb to 2 Tb of computer readable, persistent storage, and running an operating system such as LINUX or variants thereof. The operations of content management system 100 and content provider 130 as described herein can be controlled through either hardware or through computer programs installed in computer storage and executed by the processors of such server to perform the functions described herein. These systems include other hardware elements necessary for the operations described here, including network interfaces and protocols, input devices for data entry, and output devices for display, printing, or other presentations of data, but which are not described herein. Similarly, conventional elements, such as firewalls, load balancers, notes servers, failover servers, network management tools and so forth are not shown so as not to obscure the features of the system. Finally, the functions and operations of content management system 100 are sufficiently complex as to require implementation on a computer system, and cannot be performed in the human mind simply by mental steps.

Content management system 100 includes content saving module 522, which makes given content items of content provider(s) 130 available to a user via the user's account on content management system 100.

In one embodiment, content saving module 522 receives a request that specifies the user of content management system 100 for whom the content item should be saved, the content item to be saved, and content provider 130 that provides the content. For example, the request could be sent using a web-based API function, such as the CMS.saveURL function described above.

Content saving module 522 determines whether the content item has already been stored within content storage 518, and if not, obtains the content item from content provider 130 (if it has not already been obtained) and stores it within content storage 518. In the case of the embodiment described directly above, for example, content saving module 522 would determine whether there is already an entry for the URL within content storage 518 (e.g., a content item entry that has the URL as its listed source). If not, content saving module 522 would request the content item from content provider 130 (e.g., by sending an HTTP GET command with the URL as the command argument), and would save the resulting content item in content storage 518 in association with the URL. In one embodiment, content obtained from a given URL is valid only for a predefined period of time beginning at the time that the content item for that URL is stored. Accordingly, after the end of that predefined period of time for a given URL, content saving module 522 takes additional actions even if an entry already exists for the URL within content storage 518. For example, content saving module 522 may request another copy of the content item from the content provider 130 via the URL, updating the copy saved within content storage 518. Alternatively and/or additionally, content saving module 522 may perform actions to determine whether the content item currently provided for that URL by content provider 130 has changed with respect to the content item stored within content storage 518, e.g., by comparing respective checksums.

In one embodiment, when saving the content item in content storage 518, content saving module 522 adds information to content of the content item, e.g., attribution data to indicate the identity of content provider 130 or other source from which the content item was obtained. For example, content saving module 522 might embed an audio snippet (a recorded or auto-generated spoken voice) “Downloaded from www.pjap-podcasts.com” at the beginning of the downloaded podcast audio file. Similarly, content saving module 522 might place a visual watermark “Downloaded from www.myebooks.com” on each page of an electronic book downloaded from the example site myebooks.com. Adding the information to the content of the content item (as opposed to metadata, for example) means that the added information will typically be noted by the user when the content item is viewed, played, or otherwise experienced. In other embodiments, the attribution data is not added directly into the content of the content item, but rather is associated with the content item in other ways. For example, content saving module 522 could add the information to a set of metadata linked to content items of content storage 518, and content management system 100 could display the information (or otherwise cause it to be perceived) when presenting the content item users. For instance, content management system 100 could generate a preview of a content item for user viewing, such that the preview includes the information, even though the information is not saved within content of the content item itself.

In some embodiments, content saving module 522 may use techniques other than examining the URL to determine whether content storage 518 already contains the content item. For example, in one embodiment content saving module 522 maintains an index for the content items; the index may be a hash table or other data structure. A digital fingerprint can be computed for each content item using a hash function, such as MD5 or SHA-1, or the like. The content saving module 522 obtains a digital fingerprint for the content item (e.g., by requesting it from content provider 130 via a corresponding URL, as above, and then computing the digital fingerprint based on data of the content, or by requesting from content provider 130 a checksum that was previously computed and stored), and the saving module 522 computes the digital fingerprint for the content item and determines whether the index already contains a content item identifier at the location in the index corresponding to the digital fingerprint, to determine whether the content item has already been stored in content storage 518. If the location corresponding to the digital fingerprint does not already contain a content item identifier, then the content saving module 522 adds an identifier of the content item at that location in the index. If one or more content item identifiers are already present at the location, content saving module 522 may more specifically compare the content of the content item with the content of the content item(s) associated with the content item identifiers already present at the location to determine whether they represent the same content item.

Regardless of whether the content item to be saved was already present within content storage 518, or whether it was necessary for content saving module 522 to obtain it from corresponding content provider 130, the end result is that the content item is present within content storage 518. Content saving module 522 makes the content item available to the given user on the content management system, e.g., by adding an identifier of the user to the metadata of the content item within content storage 518, or by adding an identifier of the content item to user account database 516 or other user-specific information of content management system 100, for example.

In one embodiment, content management system 100 includes a content subscription module 524 that handles user subscriptions to content that is made available on an ongoing basis. (As an example, the sample set of podcasts illustrated in FIG. 2 may be subscribed to via button 220. The set of podcasts constitutes a subscription. More generally, a “subscription” represents a plurality of content items provided by a particular content provider 130 over a period of time to a user.) In some embodiments, content subscription module 524 handles both the initial establishment of a subscription by a user and also the subsequent obtaining of the content items made available as part of the subscription.

When establishing an initial subscription, content subscription module 524 receives, as input, a unique identifier of the user (e.g., a username) to be subscribed and subscription information describing the details of the subscription. The subscription information can then be used to obtain new content items that are provided as part of the subscription. In one embodiment, the subscription information includes a URL at which the content item is to be obtained, and optionally an indicator of a frequency at which to check for new content items. More generally, the subscription information may include any form of description of the location and update frequency of content in the subscription, or any type procedural instructions used to obtain new content items, that subscription module 524 can use to obtain the subscription content. The subscription information may further include additional information, such as a description of a request format expected by content provider 130 when receiving requests for content items within the subscription.

Subscription module 524 stores subscription information within subscription database 526. As described below, subscription database 526 may group subscription information for different users, only storing one set of subscription information for a given subscription, regardless of the number of users who have that subscription. Similarly, subscription module 524 need only obtain one copy of a new content item provided as part of a subscription, regardless of the number of users of content management system 100 that have that subscription.

With the subscription information received, in one embodiment the subscription module 524 requests new content items that are part of the subscription. For example, if the subscription information specified that new content items are typically added weekly, then subscription module 524 would be configured to schedule to request a new content item once per week. Depending on the request protocol used by the particular content provider 130 providing the subscription (e.g., as specified in the subscription information), subscription module 524 might send a request specifying an identifier corresponding to the subscription and an indicator of the last content item received as part of the subscription, such as the name of the content item or a date of the last content item receipt. Referring to prior examples, subscription module 524 might send a request to www.pjap-podcasts.com indicating the subscription “historical” (e.g., indicating a subscription to podcasts about historical topics) and that the last update was on Jun. 22, 2013, e.g., as an HTTP “GET” request for URL http://www.pjab-podcasts.com/subscriptions?sub=historical&last=20130622. Content provider 130 could then provide any content items in the given subscription that became available after the given date, for example. Alternatively, in some embodiments content provider 130 provides information about any such content items (rather than the data for the content items themselves), such as the filenames or other identifiers of the content items, checksums or other fingerprints of data of the content items. Based on the information, subscription module 524 of content management system 100 determines whether its content storage 518 already includes those content items, requesting the content items that it does not yet have by sending a request message to content provider 130.

In one embodiment, the subscription module 524 may adjust the frequency with which it requests updates based on the availability of new items in response to prior requests. For example, if no new content items were available in a subscription 30% of the time that the subscription module 524 requested new content items, the subscription module 524 might increase the time period that it waits before requesting a new content item, regardless of any update frequency information indicated by the subscription information of content provider 130. Conversely, if multiple content items were available in response to a request, the subscription module 524 might decrease the time period.

In one embodiment, for each subscription, subscription module 524 groups the subscriptions of all, or some subset of, the users of content management system 100. For example, subscription module 524 could identify all users with the same subscription (e.g., all users who have subscribed to the subscription for the topic “historical” at www.pjap-podcasts.com) and only send a single update request to content provider 130 on behalf of all of the identified users with the same subscription. In one embodiment, subscription module 524 accomplishes the grouping by checking at the time of subscription establishment for a user whether one or more other users have already created that subscription. If so, the subscription module 524 adds the user to subscription database 526 as one of the users who has the subscription; if not, the subscription module 524 stores new subscription information for that subscription in subscription database 526, listing the user as the only user with that subscription.

Once subscription module 524 has obtained a new content item as part of a subscription, subscription module 524 saves the content item in the same way as done by content saving module 522. For example, in embodiments in which subscription module 524 groups subscription information for different users, subscription module 524 determines whether the newly-obtained content item is already present within content storage 518, saving it within content storage 518 if not, and otherwise refraining from saving it. Then, for each of the users listed in subscription database 526 as sharing that subscription, subscription module 524 makes the content item available to those users, e.g., by associating the users with the content item in the entry for the content item within content storage 518.

In some embodiments, content provider 130 itself handles the subscription, rather than the content subscription module 524 handling the subscription on its behalf. In these embodiments, content provider 130 stores the subscriptions of users of the content management system, and whenever a new content item is made available for one of those subscriptions the content provider notifies the content management system 100. For example, if 10,000 users of content management system 100 had a particular subscription to content of a given content provider 130, upon availability of a new content item for that subscription, the content provider would send a message to content management system 100 to apprise it of the availability of the content item, and the content management system would receive the message. The contents of the message could differ in different embodiments. For example, the message could contain a list of identifiers of all the users of content management system 100 who are subscribed, or (alternatively) the message might not specify the users of the subscription, instead relying on content management system 130 to identify the users associated with the subscription. As another example, the message could include the data of the content item itself, or it could include information enabling content management system 130 to obtain the content item, such as a URL indicating the content provider 130 and the subscription (e.g., the URL http://www.pjab-podcasts.com/subscriptions?sub=historical).

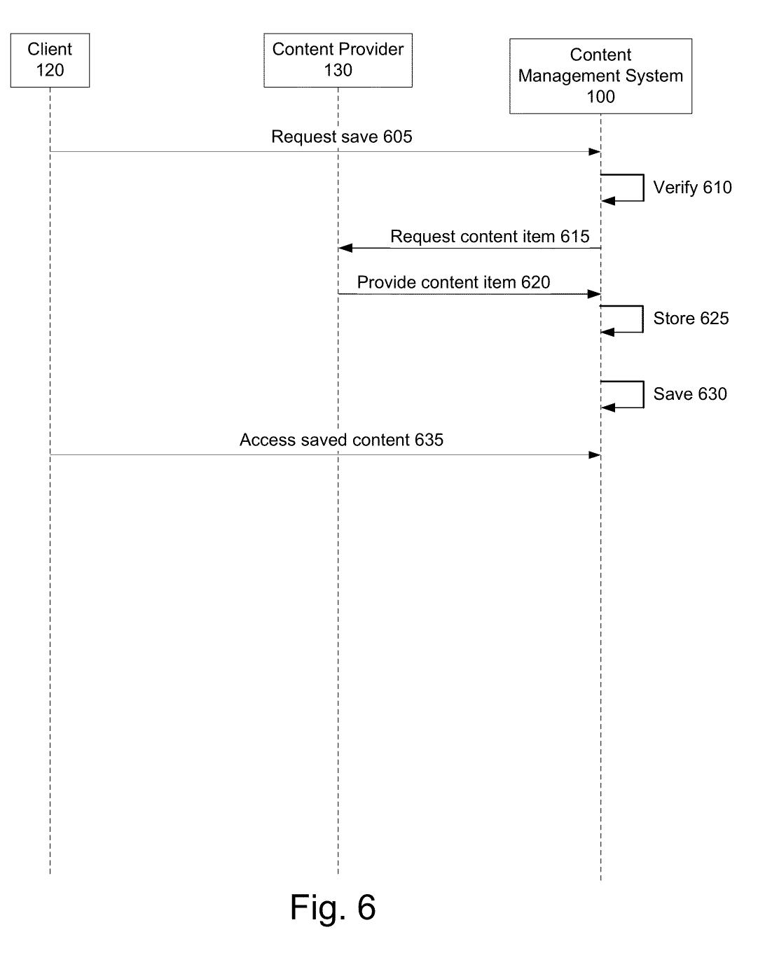

FIG. 6 shows actions that take place when a user saves a single content item, according to one embodiment. Client device 120 of a user requests 605 saving a given content item of content provider 130 in association with the user's account in content management system 100. The request might be triggered, for example, in response to the user using the “Save to CMS” button 217 of FIG. 2 and (in some embodiments) specifying attributes of the save operation using the “Save” button 356 of FIG. 3. The request itself may be implemented using a call to a web services API of content management system 100 that takes place upon use of button 217 and/or 356, and in one embodiment specifies an identity of the user on content management system 100 and the particular content item to be saved. In one embodiment request 605 is made directly from client device 120 to content management system 100, as shown in FIG. 6, and includes an identifier of content provider 130 from which content management system 100 can obtain the content item. In other embodiments, request 605 is sent first to content provider 130, which in turn sends the request to content management system 100.

Content management system 100 verifies 610 whether the specified content item has already been stored within content storage 518. If the content item has not already been stored within content storage 518, content management system 100 requests 615 the content item from the content provider 130. Content provider 130 accordingly provides 620 the content item to the content management system, which stores the received content item within the content storage 518. Content management system 100 then saves 630 the content item in association with an account of the user on content management system 100, such as by adding an identifier of the user to the metadata of the content item within content storage 518. (Note that if verification step 610 indicated that the content item was already stored in content storage 518, then steps 615, 620, and 625 would be omitted, instead skipping to step 630.)

With the content item saved 630 in association with the user's account on content management system 100, when the user's client device 120 accesses 635 the saved content, it will be treated like other content items of content management system 100. For example, the content item will typically be synchronized with other client devices 120 of the user, and not just available on the particular client device that issued the request 605. Similarly, the content item can be viewed, emailed or otherwise shared, and the like, using existing functionality of the content management system 100 as illustrated in FIG. 5.

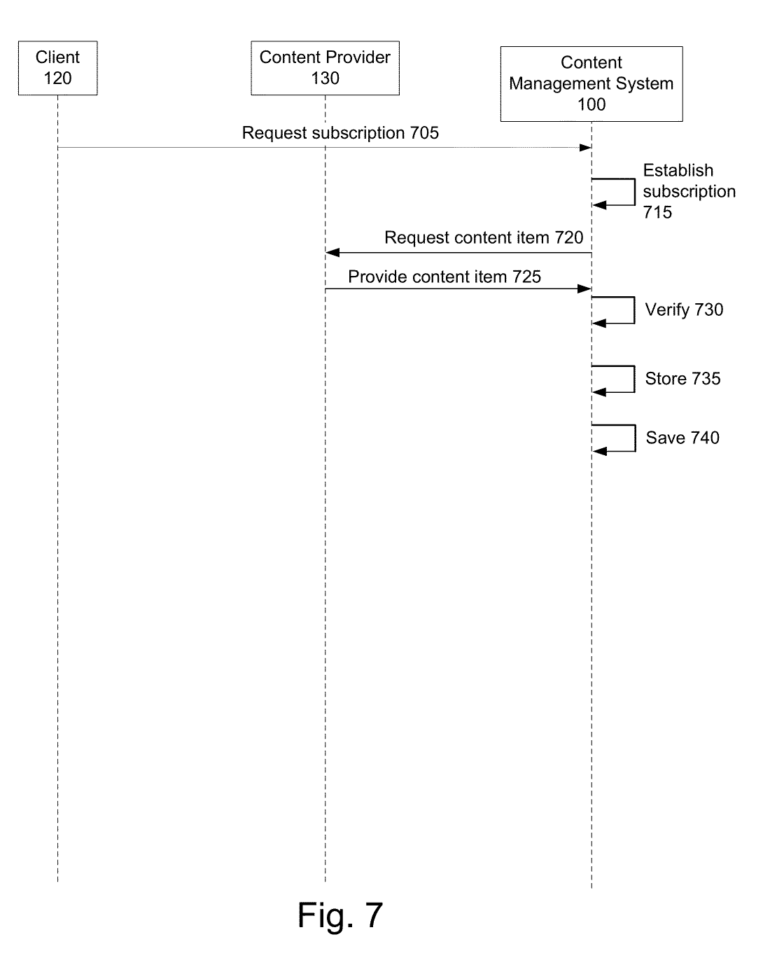

FIG. 7 shows actions that take place when a user obtains content items via a subscription, according to an embodiment in which content management system 100 handles the details of subscriptions.

Initially, a user uses a client device 120 to request 705 the establishment of a subscription to a particular set of content of a given content provider 130, the content items of the subscription to be saved in association with the user's account on content management system 100. The request might be triggered, for example, in response to the user using the “Subscribe via CMS” button 220 of FIG. 2. The request may be implemented using a call to a web services API of content management system 100 that takes place upon use of button 220, and in one embodiment specifies an identity of the user on the content management system and subscription information describing details of the subscription, as described above with respect to subscription module 524. In one embodiment, the request 705 is sent directly from client 120 to content management system 100, as shown in FIG. 7; in other embodiments, the request is first sent to content provider 130, which then provides the request to content management system 100.

Content management system 100 establishes 715 the requested subscription by storing the subscription information in association with the user identifier within subscription database 526 of FIG. 3. This stored information permits the content management system to obtain new content items that are part of the subscription by requesting 720 new content items. The requests 720 may be made at times calculated using an update frequency specified within the subscription information, for example. As noted above, in some embodiments only one request is made per subscription to particular content, regardless of the number of users of the content management system 100 who have the same subscription.

In response to request 720, content provider 130 provides 725 any new content items, as described above with respect to subscription module 524 of FIG. 5. For each provided content item, content management system 100 verifies 730 that the content item is not already stored in the content storage 518, storing 735 the content item if not. Content management system 100 then saves 740 each newly-stored content item in association with an account of each of the users on content management system 100 who have the subscription. Accordingly, each subscribed user will have access to the content item as part of the user's account on content management system 100. Content management system 100 may further synchronize, for each user who has the subscription, each newly-stored content item with each of the user's client devices that is registered with the content management system 100. Thus, a single download of a content item as part of a subscription may result in the content item being synchronized to many devices of many users. For example, if 10,000 users of content management system 100 shared a subscription and had an average of 3 registered devices each, then a single content item downloaded as part of the subscription would result in the content item being synchronized to approximately 30,000 devices.

It is appreciated that steps 720-740 (or a subset thereof, such as steps 720-730 in the case of a content item that is already stored in content storage 518) may be performed any number of times, not merely once, as illustrated in FIG. 7.

In the example of FIG. 7, the content management system 100 handles the details of subscriptions. It is appreciated that in other embodiments content provider 130 handles the details of the subscriptions, or content provider 130 and content management system 100 together handle the details, as described above with respect to content subscription module 524 of FIG. 5.

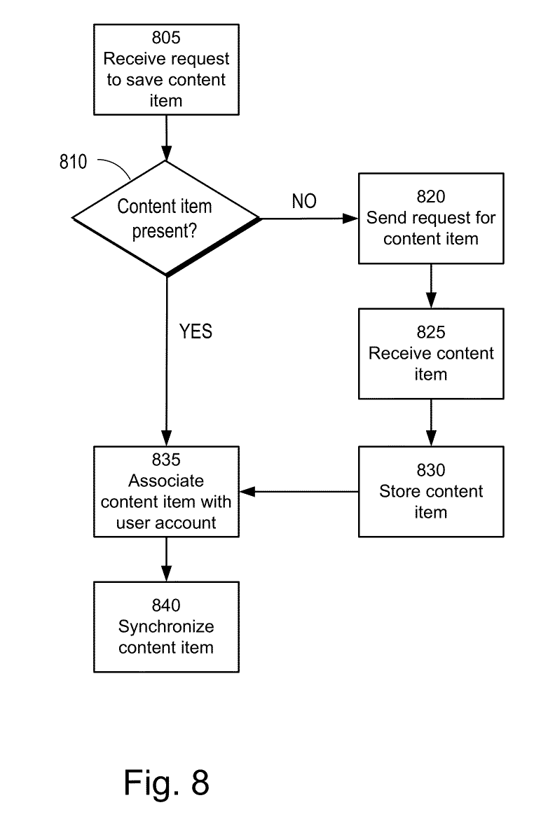

FIG. 8 shows actions that take place when a user saves a single content item, according to one embodiment.

Content management system 100 receives 805 a request from a user to save a content item of content provider 130. The request might be triggered, for example, in response to the user using the “Save to CMS” button 217 of FIG. 2.

Content management system 100 determines 810 whether the content item is both already present within content storage 518 and also still valid, e.g., by determining whether there is already an entry for a URL of the content item that was included in the request, or by computing a digital fingerprint of the content item and comparing it with fingerprints of content items already present within content storage 518, and (if there is already an entry) by determining whether less than a predetermined amount of time has elapsed since the content item was stored.

If the content item is not already present, content management system 100 sends 820 a request for the content item to content provider 130 and in response receives 825 the content item from the content provider. (Alternatively, in an embodiment in which digital fingerprints are used to determine whether the content item is already stored in content storage 518, the content item is obtained, and its digital fingerprint computed, before step 810, rather than after step 810 as shown in FIG. 8.) The content item is then stored 830 in the content storage.

Regardless of whether the content item was present or not in content storage 518 at step 810, the content item is associated 835 with an account of the user on content management system 100, such as by adding an identifier of the user to the metadata of the content item within content storage 518.

The content item is also synchronized to other client devices 120 of the user (if any), as described above with respect to the synchronization module 512.

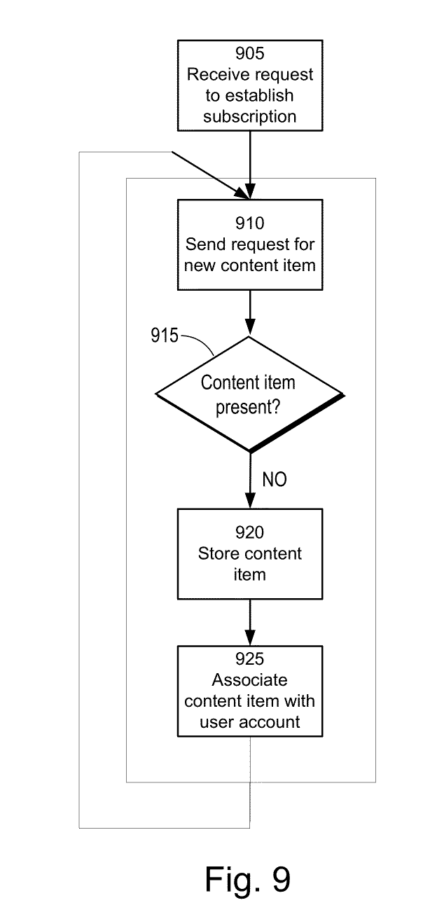

FIG. 9 shows actions that take place when a user obtains content items via a subscription, according to one embodiment.

Content management system 100 receives 905 a request from client device 120 to establish a subscription to content of content provider 130. The request might be triggered, for example, in response to a user of client device 120 using the “Subscribe via CMS” button 220 of FIG. 2.

After the subscription is established (e.g., by storing the subscription information in association with an identifier of the user within subscription database 526 of FIG. 3), content management system 100 repeatedly requests 910 new content items associate with the subscription. The requests may be sent at times calculated based on an update frequency specified in the subscription information.

After a new content item is obtained in response to the request for new content items, content management system 100 determines 915 whether the new content item is present in content storage 518. If not, content management system 100 stores 920 the new content item in content storage 518 and associates 925 the content item with an account of the user.

Reference in the specification to “one embodiment” or to “an embodiment” means that a particular feature, structure, or characteristic described in connection with the embodiments is included in at least one embodiment. The appearances of the phrase “in one embodiment” in various places in the specification are not necessarily all referring to the same embodiment.

In this description, the term “module” refers to computational logic for providing the specified functionality. A module can be implemented in hardware, firmware, and/or software. It will be understood that the named modules described herein represent one embodiment, and other embodiments may include other modules. In addition, other embodiments may lack modules described herein and/or distribute the described functionality among the modules in a different manner. Additionally, the functionalities attributed to more than one module can be incorporated into a single module. Where the modules described herein are implemented as software, the module can be implemented as a standalone program, but can also be implemented through other means, for example as part of a larger program, as a plurality of separate programs, or as one or more statically or dynamically linked libraries. In any of these software implementations, the modules are stored on the computer readable persistent storage devices of a system, loaded into memory, and executed by the one or more processors of the system's computers.

The operations herein may also be performed by an apparatus. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and displays presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the present invention as described herein, and any references below to specific languages are provided for disclosure of enablement and best mode of the present invention.

While the invention has been particularly shown and described with reference to a preferred embodiment and several alternate embodiments, it will be understood by persons skilled in the relevant art that various changes in form and details can be made therein without departing from the spirit and scope of the invention.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the following claims.

What is claimed is:

1. A computer-implemented method comprising:
receiving a request to save a content item from a content provider, the request including an identifier of an account of a user;
determining whether the content item is already present in content storage;
in response to determining that the content item is already present in the content storage:
associating the content item with the account of the user; and
in response to determining that the content item is not already present in the content storage:
sending a request to the content provider for the content item;
receiving the content item from the content provider;
storing the content item in the content storage; and
associating the content item with the account of the user; and
synchronizing the content item to each computing device associated with the user.

2. The computer-implemented method of claim 1, wherein storing the content item in the content storage comprises associating attribution information, including an identifier of the content provider, with the content item.

3. The computer-implemented method of claim 1, wherein the request to save the content item specifies a uniform resource locator (URL) corresponding to the content, and wherein determining whether the content item is already present in the content storage comprises determining whether an entry for the URL is already present within the content storage.

4. The computer-implemented method of claim 1, wherein determining whether the content item is already present in the content storage comprises comparing a digital fingerprint of the content item to digital fingerprints of content items already present in the content storage.

5. The computer-implemented method of claim 1, further comprising:
receiving, from a remote client device of the user in response to the client device loading a web page of a content provider, a request for scripting code; and
providing, to the remote client device, the requested scripting code;
wherein the request to save the content item is received responsive to the scripting code calling a web-based application programming interface (API).

6. A non-transitory computer-readable storage medium having executable computer program instructions embodied therein, the instructions comprising:
instructions for receiving a request to save a content item from a content provider, the request including an identifier of an account of a user;
instructions for determining whether the content item is already present in content storage;
instructions for, in response to determining that the content item is already present in the content storage:
associating the content item with the account of the user; and
instructions for, in response to determining that the content item is not already present in the content storage:
sending a request to the content provider for the content item;
receiving the content item from the content provider;
storing the content item in the content storage;
associating the content item with the account of the user; and
instructions for synchronizing the content item to each computing device associated with the user.

7. The non-transitory computer-readable storage medium of claim 6, wherein storing the content item in the content storage comprises adding attribution information, including an identifier of the content provider, to content of the content item.

8. The non-transitory computer-readable storage medium of claim 6, wherein the request to save the content item specifies a uniform resource locator (URL) corresponding to the content, and wherein determining whether the content item is already present in the content storage comprises determining whether an entry for the URL is already present within the content storage.

9. The non-transitory computer-readable storage medium of claim 6, wherein determining whether the content item is already present in the content storage comprises computing comparing a digital fingerprint of the content item to digital fingerprints of content items already present in the content storage.

10. The non-transitory computer-readable storage medium of claim 6, further comprising:
receiving, from a remote client device of the user in response to the client device loading a web page of a content provider, a request for scripting code; and
providing, to the remote client device, the requested scripting code;
wherein the request to save the content item is received responsive to the scripting code calling a web-based application programming interface (API).

11. A computer server comprising:
a computer processor; and
a computer-readable medium storing a computer program executable by the computer processor, the computer program comprising:
instructions for receiving a request to save a content item from a content provider, the request including an identifier of an account of a user;
instructions for determining whether the content item is already present in content storage;
instructions for, in response to determining that the content item is already present in the content storage:
associating the content item with the account of the user; and
instructions for, in response to determining that the content item is not already present in the content storage:
sending a request to the content provider for the content item;
receiving the content item from the content provider;
storing the content item in the content storage;
associating the content item with the account of the user; and
instructions for synchronizing the content item to each computing device associated with the user.

12. The computer server of claim 11, wherein storing the content item in the content storage comprises adding attribution information, including an identifier of the content provider, to content of the content item.

13. A computer-implemented method comprising:
receiving a request to establish a subscription to content of a remote content provider, the request specifying a uniform resource locator (URL) corresponding to the content and an identifier of an account of a user;
obtaining updated content for the subscription of the user by repeatedly performing the following:
sending a request to the content provider for a new content item associated with the URL;
responsive to receiving a new content item associated with the URL from the content provider:
determining whether a copy of the new content item is already present in content storage;
in response to determining that the copy of the new content item is not already present in the content storage:
storing a copy of the new content item in the content storage; and
associating the copy of the content item with the account of the user.

14. The computer-implemented method of claim 13, further comprising:
identifying a group comprising the user and other users having a subscription to the same content, and
refraining from sending the request to the content provider for new content items on behalf of the other users of the group.

15. The computer-implemented method of claim 13, wherein the request to establish the subscription of the account comprises an indicator of a frequency of new content items associated with the subscription, and further comprising calculating times at which to carry out the repeated performing using the indicator of the frequency.

16. The computer-implemented method of claim 15, wherein calculating times at which to carry out the repeated performing additionally comprises calculating a frequency that new content items have been provided in response to previous requests for new content items associated with the subscription.

17. The computer-implemented method of claim 13, further comprising:
synchronizing the copy of the new content item across the client devices of the user.

18. The computer-implemented method of claim 13, wherein storing a copy of the new content item in the content storage comprises adding attribution information including an identifier of the content provider to content of the new content item before storing the new content item in the content storage.

19. The computer-implemented method of claim 13, wherein determining whether a copy of the new content item is already present in the content storage comprises determining whether an entry for the URL is already present within the content storage.

20. The computer-implemented method of claim 13, wherein determining whether a copy of the new content item is already present in the content storage comprises comparing a digital fingerprint of the new content item to digital fingerprints of content items already present in the content storage.
